(19) United States
(12) Patent Application Publication
(10) Pub. No.: US 2009/0141808 A1
(43) Pub. Date: Jun. 4, 2009

(54) SYSTEM AND METHODS FOR IMPROVED VIDEO DECODING

(76) Inventor: Yiufai Wong, Bellevue, WA (US)

Correspondence Address: XIN WEN, 3449 RAMBOW DRIVE, PALO ALTO, CA, 94306, US

(21) Appl. No.: 11/947,988

(22) Filed: Nov. 30, 2007

(51) Int. Cl. H04B 1/66

(52) U.S. Cl. 375/240.25; 375/E07.076

(57) ABSTRACT

A video decoding system includes receives video data comprising a first input video frame and a second input video frame. The first input video frame includes a block encoded by an M×N array of DCT coefficients for the first input video frame. A subset of the M×N DCT coefficients in the block is selected. The selected DCT coefficients are dequantized and inversely transformed to produce a reduced pixel block. The video decoding system computes a reduced motion vector associated with the reduced pixel block between the first input video frame and the second input video frame. A motion-compensated reduced block is computed based on the pixel block according to the reduced motion vector. The motion-compensated reduced block is added to the reduced pixel block to form a portion of an output video frame.

### BACKGROUND

The present disclosure relates to processing and decoding compressed video signals.

MPEG are standards for video and audio compression developed by the Moving Picture Experts Group (MPEG). MPEG-1 was designed specifically for Video-CD and CD-i media, for coding progressive video at a transmission rate of about 1.5 million bits per second. MPEG-2 was designed for coding interlaced images at transmission rates above 4 million bits per second. The MPEG-2 standard is used for various applications, such as digital television (DTV) broadcasts, digital versatile disk (DVD) technology, and video storage systems. According to the MPEG-2 standard, a video sequence is divided into a series of Group of Pictures (GOPs). Each GOP begins with an Intra-coded picture (I picture) followed by an arrangement of forward Predictive-coded pictures (P pictures) and Bi-directionally predictive-coded pictures (B pictures). I pictures are fields or frames coded as a stand-alone still image. P pictures are fields or frames coded relative to the nearest I or P picture, resulting in forward prediction processing. P pictures allow more compression than I pictures through the use of motion compensation, and also serve as a reference for B pictures and future P pictures. B pictures are coded with fields or frames that use the most proximate past and future I and P pictures as references, resulting in bi-directional prediction.

Digital video applications have become increasingly popular in recent years. Digital video signals can now be streamed to mobile devices, to computers over the Internet, and to Digital TV at homes. A challenge for digital video application is that advanced audio/visual processing functions tend to consume more computational power than is often available. For example, a key element in MPEG-2 processing is MPEG-2 decoding, which converts a bitstream of compressed MPEG-2 data into pixel images. MPEG-2 decoding typically includes functions such as variable length decoding, dequantization, inverse discrete cosine transform system (IDCT), and motion compensation (MC). Each of these functional components usually consumes significant amount of computational power, which drives up the cost, and limits the flexibility of digital video systems using MPEG-2 technology. Accordingly, there is a need to provide highly efficient and cost effective video decoding system.

### SUMMARY

In one general aspect, the present invention relates to a system for video decoding. The system includes a first functional unit configured to receive video data comprising a first input video frame and a second input video frame, wherein the first input video frame comprises a block encoded by an M×N array of DCT coefficients for the first input video frame and to select a subset of the DCT coefficients in the M×N array to obtain selected DCT coefficients, wherein M and N are integers; a second functional unit that can dequantize the selected DCT coefficients to produce dequantized DCT coefficients without dequantizing the DCT coefficients that are not selected by the first functional unit; a third functional unit configured to inversely transform the dequantized DCT coefficients to produce a reduced pixel block; a fourth functional unit that can produce a reduced motion vector associated with the reduced pixel block between the first input video frame and the second input video frame, wherein the fourth functional unit can produce a motion-compensated reduced block based on the pixel block according to the reduced motion vector; and a fifth functional unit that can add the motion-compensated reduced block to the reduced pixel block to form a portion of an output video frame.

In another general aspect, the present invention relates to a computer program product, encoded on a tangible program carrier, operable to cause data processing apparatus to perform operations comprising: receiving video data comprising a first input video frame and a second input video frame, wherein the first input video frame comprises a block encoded by an M×N array of DCT coefficients for the first input video frame; selecting a subset of the DCT coefficients in the M×N array to obtain selected DCT coefficients, wherein M and N are integers; dequantizing the selected DCT coefficients to produce dequantized DCT coefficients without dequantizing the DCT coefficients that are not selected by the first functional unit; inversely transforming the dequantized DCT coefficients to produce a reduced pixel block; producing a reduced motion vector associated with the reduced pixel block between the first input video frame and the second input video frame; producing a motion-compensated reduced block based on the pixel block according to the reduced motion vector; and adding the motion-compensated reduced block to the reduced pixel block to form a portion of an output video frame.

In another general aspect, the present invention relates to a method for video decoding. The method includes receiving video data comprising a first input video frame and a second input video frame, wherein the first input video frame comprises a block encoded by an M×N array of DCT coefficients for the first input video frame; selecting a subset of the M×N DCT coefficients in the M×N array to obtain selected DCT coefficients, wherein M and N are integers; extracting the selected DCT coefficients in the M×N array from the video data without extracting from the video data the DCT coefficients that are not selected in the M×N array; dequantizing the selected DCT coefficients to produce dequantized DCT coefficients without dequantizing the DCT coefficients that are not selected by the first functional unit; inversely transforming the dequantized DCT coefficients to produce a reduced pixel block; producing a reduced motion vector associated with the reduced pixel block between the first input video frame and the second input video frame; producing a motion-compensated reduced block using the reduced pixel block and the reduced motion vector; and adding the motion-compensated reduced block to the reduced pixel block to form an output reduced pixel block.

In another general aspect, the present invention relates to a method for video decoding. The method includes receiving video data comprising a first input video frame and a second input video frame, wherein the first input video frame comprises a block encoded by an M×N array of DCT coefficients for the first input video frame; selecting P×Q of M×N DCT coefficients in the M×N array to obtain selected DCT coefficients, wherein at least one of the selected DCT coefficients is associated with a frequency lower than that associated with one of the DCT coefficients in the M×N array not selected in the step of selecting, wherein M, N, P, and Q are integers, P×Q is smaller than M×N, and M/P and N/Q define scaling factors between the block and the reduced block; extracting the selected DCT coefficients in the M×N array from the video data without extracting from the video data the DCT coefficients that are not selected in the M×N array; dequantizing the selected DCT coefficients to produce dequantized DCT coefficients without dequantizing the DCT coefficients that are not selected by the first functional unit; inversely transforming the dequantized DCT coefficients to produce a reduced pixel block; extracting from the video data an original motion vector associated with the displacement of the block between the first input video frame and the second input video frame; computing a reduced motion vector associated with the reduced pixel block between the first input video frame and the second input video frame in response to the original motion vector and the scaling factors; producing a motion-compensated reduced block using the reduced pixel block and the reduced motion vector; and adding the motion-compensated reduced block to the reduced pixel block to form an output reduced pixel block.

Implementations of the system may include one or more of the following features. At least one of the selected DCT coefficients in the M×N array can be associated with a frequency lower than that associated with one of the DCT coefficients not selected in the M×N array in the step of selecting. The selected DCT coefficients can form a P×Q array, wherein P and Q are integers, M/P and N/Q can define scaling factors between the block and the reduced block. At least one of M/P or N/Q can be a power of 2. The method can further include extracting from the video data an original motion vector associated with the displacement of the block between the first input video frame and the second input video frame; and computing the reduced motion vector using the original motion vector, M/P, and N/Q. The method can further include computing the reduced motion vector by dividing a component of the original motion vector by M/P or N/Q. The method can further include filtering the output reduced pixel block to remove artifacts along the boundaries of the output reduced pixel block. The method can further include determining a processing frequency or a memory size characterizing a computing system configured to execute the steps of selecting, extracting, dequantizing, inversely transforming, producing a reduced motion vector, producing a motion-compensated reduced block, or adding; and determining M/P and N/Q in accordance with the processing frequency or the memory size characterizing the computing system.

Various implementations of the methods and devices described herein may include one or more of the following advantages. The disclosed system and methods are able to decode video bitstream faster than some conventional video decoding systems. The faster video decoding can allow real-time video decoding to be achieved in a wide range of hardware configurations, where real-time video decoding is previously not possible. For video codec decoding system that uses specialized integrated circuits (IC), the disclosed systems and methods allow simpler decoding circuits with fewer gate counts and less memory usage. As a result, the IC can be cheaper to manufacture or run at a lower clock frequency, which can result in significant reduction in die size, cost and power consumption.

The disclosed system and methods are flexible. They are applicable to essentially all the open coding standards such as H.263, MPEG1, MPEG2, MPEG4, H.264, VC-1, and AVS (China standard), as well as proprietary compression/decompression standards such as WMV, RealVideo, DIVX and XVID.

Moreover, the disclosed system and methods can also be flexibly implemented. The disclosed system and methods can be implemented as embedded software that runs on Central Processing Unit (CPU) and Digital Signal Processor (DSP), or in dedicated integrated circuit such as application specific integrated circuit (ASIC). The disclosed system and methods can also be implemented in firmware stored in non-volatile computer memories.

Furthermore, the disclosed decoding system and methods are not bound by certain limitations in some conventional video standards. The decoding can be conducted at high speed while producing video images at acceptable level of image quality.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles, devices and methods described herein.

FIG. 1 is a schematic diagram of a video encoding system.

FIG. 2 is a schematic diagram, of a video decoding system.

FIG. 3 is a schematic diagram of a fast video decoding system. Image resolution at each step is shown in parentheses. Exemplified pixel sizes of the macroblocks and blocks at different functional units are shown in brackets.

FIG. 4 illustrates the reduction of block sizes in the inverse transform in FIG. 3.

FIG. 5A illustrates motion compensation based on the original macroblock.

FIG. 5B illustrate motion compensation based on a reduced block.

FIG. 6 illustrates reduced motion vectors and reduced reference frames corresponding to the reduced block size in FIG. 5B.

FIG. 7 illustrates an adaptive video decoding system.

### DETAILED DESCRIPTION

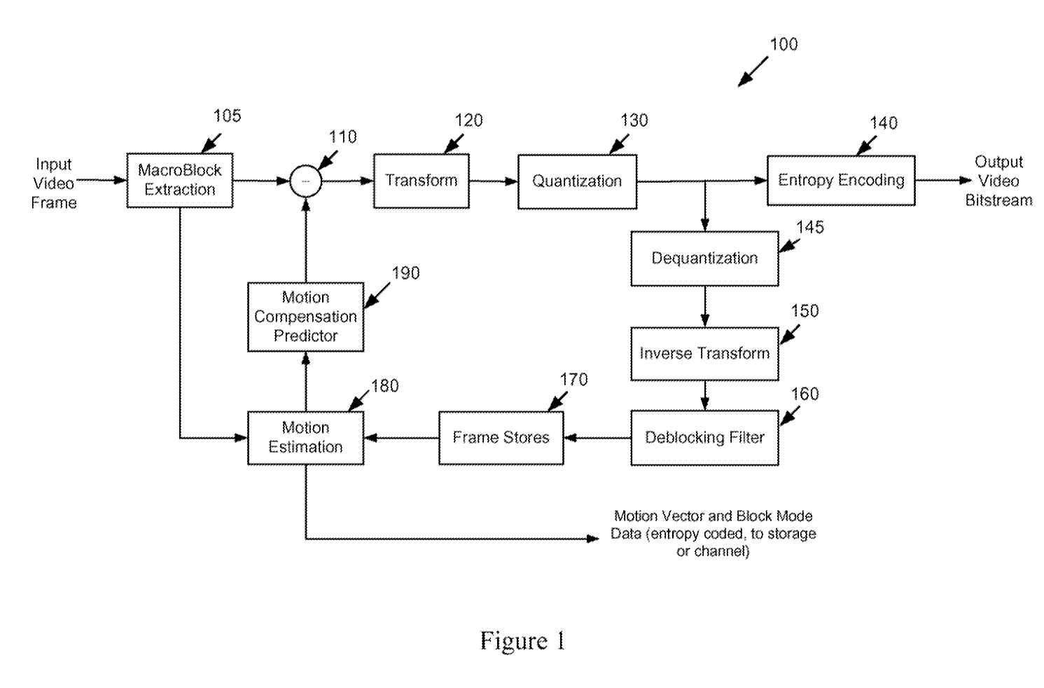

Referring to FIG. 1, a video encoding system 100 can include the following functional units: macroblock extraction 105, a subtraction functional unit 110, a functional unit 120 for transform, a functional unit 130 for quantization, a functional unit 140 for entropy encoding, a functional unit 145 for dequantization, a functional unit 150 for inverse transform, deblocking filter 160, frame stores 170, a functional unit 180 for motion estimation, and a motion estimation 190 for motion compensation.

It should be noted that the terms used in the present specification are meant to describe building blocks, components, and functional steps without limiting to a specific standard. It is understood that the exact terms for functional steps and building blocks may differ among different video compression/decompression standards. For example, Variable length coding (VLC) can be used in MPEG 1, MPEG 2 and MPEG 4 standards. H.264 uses additional tools such as CAVLC (Context-based Adaptive Variable Length Coding) or CABAC (Context-based Adaptive Binary Arithmetic Coding). In the present specification, the term “VLC” is used to refers to variable length coding such as VLC, CAVLC, CABAC, or other variations of VLC used in the open standards or proprietary codecs for entropy coding. Similarly, Discrete Cosine Transform (DCT) is used in MPEG 1, MPEG 2 and MPEG 4 standards, while Integer Transform is used in H.264.

In the present specification, the term macroblock refers to pixel blocks in the input video frames as defined by the associated video codecs. The size of the macroblock can be dependent on the specification of the existing video codecs. For example, the pixel blocks can be 16×16 in size. Due to numerous ways these macroblocks can be divided into blocks and sub-blocks in the various video codecs specifications, the term block refer to the block and subblock. In the present specification, the term “DCT” refers to Discrete Cosine Transforms and other transforms used in the open standards and proprietary codecs without limiting to specific coding standards or block sizes. Similarly, motion compensation in the disclosed systems and methods are compatible with different codecs using different interpolation schemes and filter taps.

An input video frame is received by the functional unit 105. The input video frame can, for example, be encoded as Intra, Inter or Bi-directional pictures (I, P, B). The disclosed methods and systems are compatible with other video encoding techniques. The input video frame can have luminance (Y) and chrominance (U, V) components. Examples for the input video formats include 4:2:0, 4:2:2 or 4:4:4 depending on the video codec specification. For the 4:2:0 format, the dimension of Y is two times that of U and V component in both horizontal and vertical directions. The systems and methods disclosed in the present specification are illustrated using the luminance component (Y). These disclosed systems and methods can be applied to the chrominance components with proper scaling and modifications according to the video codec specifications.

I-pictures are encoded without reference to other pictures. P-pictures are encoded using previously encoded video frames as reference frames. In P-picture encoding, one performs a process such as motion estimation to estimate the current frame based on the reference frames.

In I-picture encoding, the input video frame is divided into macroblocks. The macroblock typically have dimensions of 16×16 pixels. The functional unit 105 extracts the macroblock from the input video frame. Depending on coding options used in the encoder, the block extraction 105 can further divide the macroblocks into 8×8 pixel blocks. Depending on the particular codec used, a block can be further divided into sub-blocks. For example, in MPEG1 or MPEG2, the blocks are [8×8] in size and are not further divided. In H.264, an 8×8 block can be further divided into four [4×4] subblocks. As mentioned above, the term block refers to both blocks and subblocks in the present specification.

In the present specification, the sizes of the macroblocks and blocks are represented in brackets [ ]. The image resolutions are indicated by parentheses ( ). Scale factors for the macroblocks or image resolutions are shown in curly brackets { }.

The block produced by the functional unit 105 is transformed in the functional unit 120, which produces transform coefficients. The transforms can include DCT in MPEG1, MPEG2 and MPEG4, integer transform in H.264, transforms in WMV9 and so on. The transform coefficients are then quantized in the functional unit 130. In the functional unit 140, quantized transform coefficients and other information related to the blocks are encoded by entropy techniques such as VLC, CAVLC and CABAC to produce an output video bitstream. The output video bitstream is then stored or transmitted through a communication channel. The video bitstream contains enough information for a reconstruction of the input video frame.

For encoding of the next input video frame, an encoded I-picture is constructed in the functional units 145-170. The quantized coefficients from the functional unit 130 are dequantized in the functional unit 145. The coefficients are then inversely transformed in the functional unit 150 to produce a reconstructed block (that is similar to but lossy relative to the macroblock extraction in the functional unit 105). The deblocking filter in the functional unit 160 filters the boundaries of reconstructed blocks to reduce visual artifacts such as blockiness. If the deblocking filter is turned off, the functional unit 160 is bypassed and its output equals its input. For example, in H.264, this deblocking filter can be turned on. In MPEG4, there is no deblocking filter in the encoding process.

The reconstructed block is stored in the frame stores 170 and is used as a reference frame for the encoding of the next P-picture from the input video sequence. For I-picture encoding, the functional units 180 and 190 are not activated. After processing all the blocks in the input video frame, the video frame stored in Frame Store 170 is its reconstructed frame under encoding.

In P-picture encoding, the extracted macroblock from the functional unit 105 is processed by the functional unit 180 to search for a best matching block from the reference frame. The vector difference between the positions of the best matching block and its current position is called motion vector(s). If a best matching block cannot be found for a block according to some optimization criteria, the block is encoded as an Intra-coded block. The block is then processed like a block in an I-picture as described above, through the processing steps from the functional unit 120 to the frame stores 170. If this block is to be encoded as an Inter-coded block, the motion vector estimated in the functional unit 180 is used in the functional unit 190 to obtain a predictor block through motion compensation. The predictor block is subtracted from the input block in the functional unit 110 to obtain residual data.

For an Inter-coded block, the residual data is transformed in the functional unit 120. From then on, the same processing steps from the functional unit 130 to the functional unit 170 are conducted as described in I-picture encoding. A B-picture is encoded using one previous frame and one future frame as reference frames. As a result, the motion compensation and predictor in the functional unit 190 can have two motion vectors: one for the previous reference frame and one for the future reference frame. In the case of H.264, a video frame can have many reference frames (more than 2) and thus have many motion vectors for each Inter-coded block. The above described steps are repeated to encode all the blocks in the input video frame to obtain an output video bitstream.

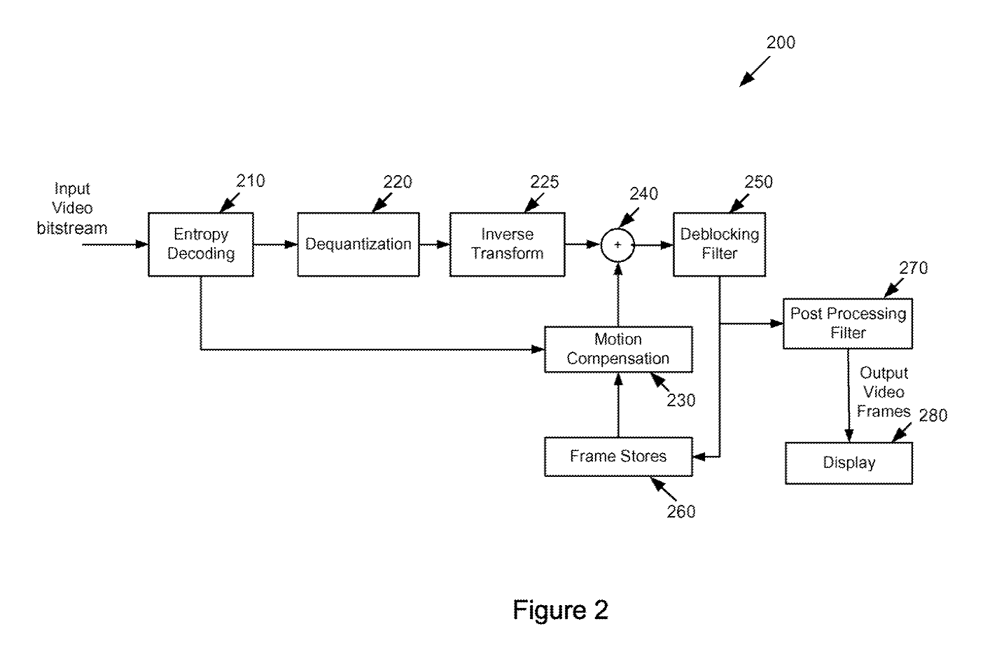

A video decoding system 200, referring to FIG. 2, can include the following functional units: a functional unit 210 for entropy decoding, a functional unit 220 for dequantization, a functional unit 225 for inverse transform, a functional unit 230 for motion compensation, an addition functional unit 240, a deblocking filter 250, and frame stores 260. The video decoding system 200 can optionally include a functional unit 270 for deblocking and post processing, and a display 280.

An input video bitstream is received by the functional unit 210. The input video bitstream can comply with a standard codec specification. The entropy decoding is conducted in the functional unit 210 by techniques such as VLC/CABAC/CAVLC decoding. The input video bitstream is parsed using VLC decoding to produce information about video coding mode (I, P, B), block coding mode (Intra, Inter), motion vector (MV) for Inter-coded blocks and quantized DCT coefficients. For example, DCT of an 8×8 block may contain up to 64 coefficients. Some coefficients may be zero. These coefficients will be parsed in this process. For the various video codec standards, there are many other different types of information contained in the bitstream.

The quantized values of the transform coefficients produced by the functional unit 210 are dequantized in the functional unit 220 to construct the DCT coefficients. The dequantized coefficients are inversely transformed (e.g. IDCT) in the functional unit 225 to obtain residual values for inter-coded blocks or the values for the intra-coded blocks.

I-picture and P-picture decoding can be different after the functional unit 225. For I-picture decoding, the output from 225 is reconstructed block. Functional unit 240 does not need any input from motion compensation 230. Just like encoding, the deblocking filter 250 may be optional, depending on the video codec standards such as (MPEG4, H.264, VC-1). The deblocking filter 250 filters pixels around block boundaries according to some criterion. If the deblocking filter is not required by the codec standard, the functional unit 250 simply passes the reconstructed block as output. The output from functional unit 250 is then stored in the Frame Stores 260, to act as reference frame for P-picture decoding. The output from the functional unit 250 can then optionally passes through post-processing filter 270 to produce decoded output video frame which is ready to be displayed in the display 280. Note that this post-processing filter 270 may be different from those used in the functional unit 250.

For P-picture decoding, the output from the functional unit 225 is called residual data. The motion vector information obtained from the functional unit 210 is used for motion compensation in the functional unit 230. Motion compensation uses reference frames stored in Frame Store 260 to produce a predicted block which is then added in the functional unit 240 to the residual data. The sum from the functional unit 240 is then processed in the functional unit 250-270. In both I-picture and P-picture decoding cases, the result from the functional unit 250 is stored in Frame Store 260 to form reference frames which are used in motion compensation 230. The method of interpolation and the range and reconstruction of the motion vectors may differ depending on the codec standards. But the idea of using interpolated values from the reference frames to predict the current block remains the same among the various video codecs. The above described steps are repeated to decode all the blocks in the input video bitstream to obtain a decoded output video frame.

For pleasant visual experience, one prefers video be decoded and rendered at 30 fps (frames per second). This is so-called real-time decoding. For handheld devices such mobile phones, portable media players or smart phone, or personal digital assistants, sometimes decoding and rendering video at 25 fps (frames per second) is real-time enough. If a computing device cannot achieve this speed when playing a video file or video bitstream, its visual experience is not pleasant and maybe unacceptable to consumers.

The speed of video decoding is dependent on the hardware configuration of the computing platform such as CPU or DSP configured with certain cache, system dock frequency and memory. For certain hardware systems, standard-compliant decoding processes cannot be conducted at a desirable speed to allow real time display. For an ARM 926 EJS processor running at 200 MHz, for example, a video bitstream at VGA (640×480) resolution cannot be decoded at 30 fps using a standard-compliant decoding process.

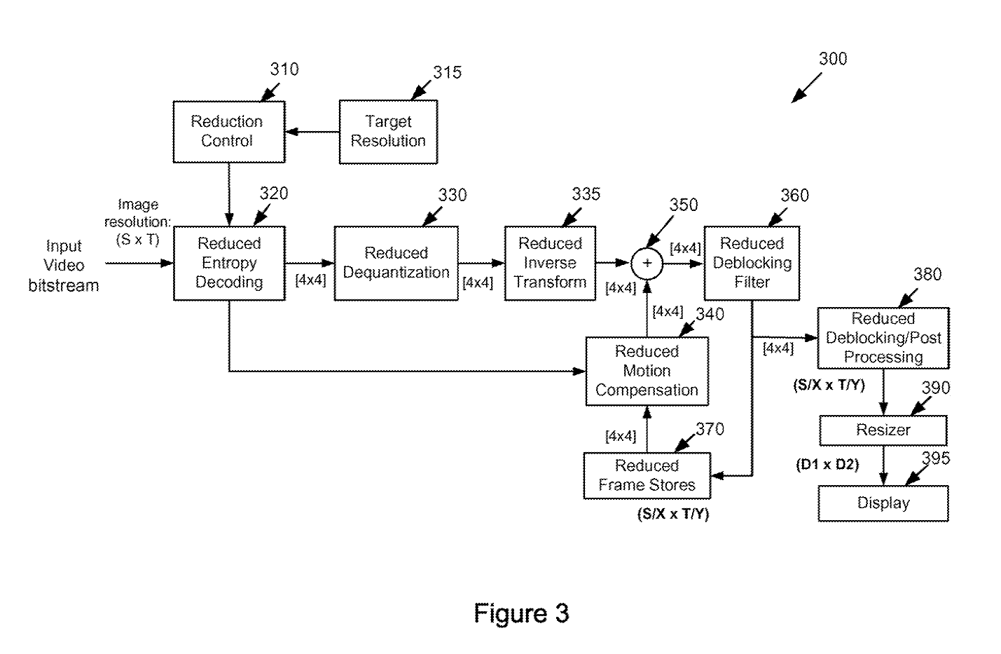

A fast video decoding system 300, referring to FIG. 3, can include the following functional units: a functional unit 310 for reduction control that receives input a target resolution from a functional unit 315, a functional unit 320 for reduced entropy decoding under the control of the functional unit 310, a functional unit 330 for reduced dequantization, a functional unit 335 for reduced inverse transform, a functional unit 340 for reduced motion compensation, an addition functional unit 350, a functional unit 360 for reduced deblocking filter, and reduced frame stores 370. The fast video decoding system 300 can also include functional unit 360 and 380 for reduced deblocking and post processing, a resizer 390, and a display 395.

An input video bitstream comprising a plurality of video frames at an image resolution (S×T) is received by the functional unit 320. The input video bitstream (also referred as video data) can be encoded in various video codecs that are either open standards or proprietary schemes. The input video bitstream comprises a series of input video frames and other pertinent information. Each input video frame can include many blocks. Each block is entropy encoded by an array of DCT coefficients. The functional unit 315 specifies a target output resolution. Based on these two inputs, the functional unit 310 decides the amount of reduction that needs to take place for each macroblock of data. For example, the functional unit 310 determines the macroblock size to be reduced by scale factors of {X} and {Y} in the horizontal and the vertical directions, wherein X and Y are bigger than one. For example X and Y are integers. A decoded macroblock has dimensions of [16/X×16/Y]. Examples for {X, Y} include {2,2}, {4,4}, {2,4}, {4,2}. As a result of the scaling in the functional unit 310, the decoded image will have dimension (S/X, T/Y) because every macroblock is scaled to [16/X×16/Y]. For example, in the case of {2,2}, an input image having a resolution of 640×480 become an output image of resolution of 320×240. A high-definition video of resolution 1920×1024 can have resolution 960×512. The reduction in image resolution is dependent on the target resolution set forth in the functional unit 315. The target resolution (S/X×T/Y) can be the same as the display resolution (D1×D2) for the output image for the fast video system 300. Alternatively, the target resolution (S/X×T/Y) can be a different image resolution that can be resized to the display resolution (D1×D2) (in the functional unit 390). For example, in the case of {4, 4}, an input image (S×T) of 640×480 is reduced to (160×120). A high-definition video of (1920×1024) is reduced to a resolution of (480×256). Exemplified input and reduced image resolutions are shown Table I, and in parentheses in FIG. 3 using exemplified scale factors of {2,2}.

TABLE 1
Comparisons of input image resolution and reduced image resolution

| Input resolution | Reduced resolution | Scale Factor |
|---|---|---|
| 640 × 480 | 320 × 240 | {2, 2} |
| 720 × 480 | 360 × 120 | {2, 4} |
| 1024 × 720 | 256 × 180 | {4, 4} |

A block of size [8×8] can be reduced to a block of size [4×4]. If the input video bitstream is in MPEG 1, MPEG 2, and MPEG 4 and other existing standards, a block of size [8×8] is now reduced to a block of size [4×4]. The subsequent video processing steps in the functional units 350, 360, 380, 340 and 370 are then based on blocks having reduced sizes [4×4] instead of [8×8] (as shown in FIG. 3). The scale factors for the block size reduction can be powers of 2 for easier computations. It should be noted, however, that the disclosed methods and systems are compatible with block sizes other than powers of 2.

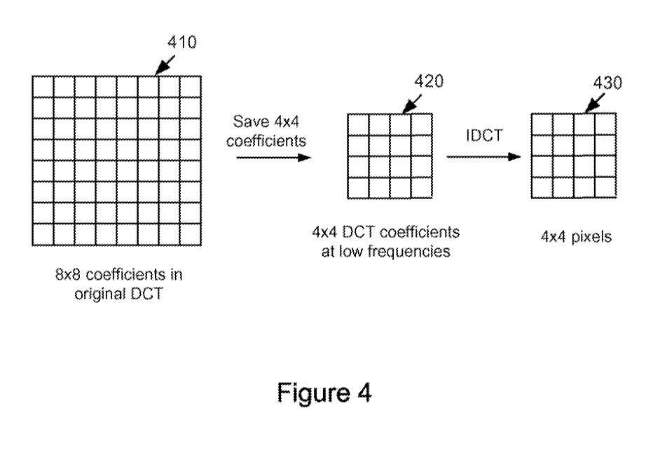

FIG. 4 illustrates an implementation of block reduction in the functional unit 335 using Inverse Discrete Cosine Transform as specified in MPEG1, MPEG2 and MPEG4. The block 410 for the original transform has a size of [8×8] for the DCT coefficients. Assuming scale factors of {2, 2}, the reduced DCT coefficients 420 have a block size of [4×4]. The reduced DCT coefficients 420 can be obtained by selecting the 4×4 lower frequency coefficients in the original [8×8] block of DCT coefficients. In some codec, the low frequency DCT coefficients are located in a quadrant of the block 410. The unused higher-frequency coefficients in the original DCT block are discarded. Then one performs 4×4 IDCTs on these 4×4 DCT coefficients to obtain the [4×4] block 430 of pixels (or pixel block).

Similarly, a macroblock in the input video frame may be divided into smaller blocks of sizes such as [8×4], [4×8], or [4×4] as done by H.264. For example, the functional unit 335 can produce subblocks of data of sizes [4×2], [2×4] and [2×2] respectively.

The above described inverse transform can be applied to various video codec standards. For example, in I-picture decoding, the reduced inverse transform produces reduced pixel blocks in each frame. In P-picture decoding, the residual blocks in a reference frame can be reduced using the process described above. The reduced P-picture also allows reduced B-picture to be produced.

Referring to FIGS. 3 and 4, the functional unit 320 only extracts the lower-frequency DCT coefficients to be used in the functional unit 335, but not the unused DCT coefficients. The higher frequency DCT coefficients are not extracted. The functional unit 335 only dequantizes the [4×4] low frequency DCT coefficients. The higher frequency DCT coefficients are not extracted and thus not dequantized. This results in the “reduced dequantization” functional unit 330 which dequantizes only the needed coefficients used in the functional unit 335. As a result, video processing times in the functional units 320 and 330 can be decreased. It should be noted that the disclosed systems and methods are applicable to MPEG1 and MPEG2 and inverse transforms in other video codecs. In contrast, in the video decoding system 200, all the DCT coefficients including the high frequency DCT coefficients are parsed in functional unit 210 and dequantized in functional unit 220.

If the original video codec specifies a filter for the boundaries of the block ([8×8]), the functional unit 360 can operate at boundary pixels in the reduced blocks. The fewer boundary pixels in the reduced blocks similarly result in increased video decoding speed. For I-picture decoding, the output from the functional unit 360 is stored in the reduced frame store 370. For an input image resolution of (S×T), a video reference frame having image resolution of (S/X×T/Y) is stored in the reduced frame store 370. Processing speed and storage efficiency are both improved.

Optionally, a post processing is performed by the functional unit 380. The boundaries of the reduced blocks are filtered to remove artifacts. Since the block size is reduced, the number of pixels around the boundaries is reduced. Hence the speed of post processing is much improved.

The fast video decoding system 300 can output video frames to be displayed at equal or lower resolutions than that specified in the input video bitstream. For example, a 3.5 inch cell phone display may have resolution 480×320. A 3 inch display may have resolution 320×240. A resizer 390 can be included before the display 395 to prepare the output video images to the display resolution. The resizing step can allow the disclosed fast video decoding system to be flexibly applied to a wide range of image resolutions for the input video bitstream and the display output. For example, as shown in Table 2, the input video resolution may be 720×480. The decoded video resolution is 360×240, a quarter of the size of the input video resolution. The resizer 390 can resize the decoded image to a resolution of 320×240 for display on a screen having 320×240 pixels.

TABLE 2
Comparisons of input, decoded and resized image resolutions

| Input resolution | Decoded resolution | Resized resolution |
|---|---|---|
| 720 × 480 | 360 × 240 | 320 × 240 |
| 640 × 480 | 320 × 240 | 320 × 240 |
| 640 × 352 | 320 × 176 | 320 × 240 |

The resizer 395 can vary the image resolution of the output video frames produced by the functional unit 380. The image resolution can be increased to be higher than that the input video bitstream. For example, a video file with an image resolution of (S×T) stored in a mobile or portable device is output a digital TV. The video file can be decoded at high speed to a resolution of (S/2×T/2) as described, above. The resizer 390 can resize the decoded video frame to a resolution of (2S×2T) or (S×T).

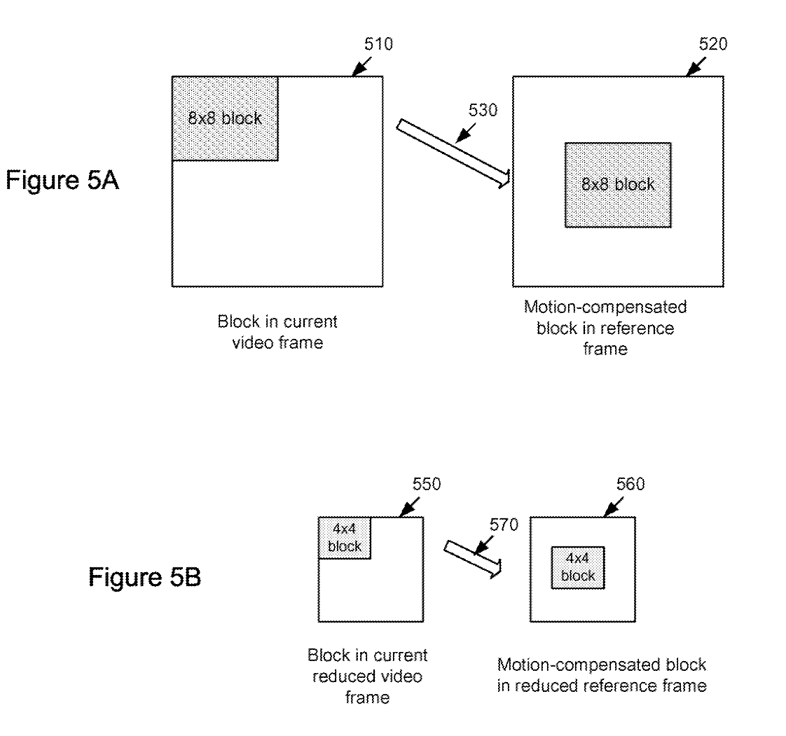

P-picture decoding is next discussed in reference to FIGS. 5A and 5B. Let us consider decoding the first P-picture immediately after decoding an I-picture. FIG. 5A illustrates exemplified motion vector and motion compensation in the video decoding system 200 illustrated in FIG. 2. The input block size in the current frame 510 is assumed to be [8×8]. A reference frame 520 is the decoded I-picture stored in Frame Stores 260. A matching block is found in the reference frame 520. A motion represented by an original motion vector V 530 identifies the movement (or displacement) from the [8×8] block in the current frame to the reference frame, which can be used in interpolating the original reference frame, to obtain a predictor for the current block. The original motion vector 530 is denoted by V=(mv_x, mv_y). The original motion vector V 530 is contained in the input video bitstream. The function unit 320 can extract the original motion vector V 530 from the input video bitstream and send it to the functional unit 340.

In the fast video decoding system 300, the reference frame for the P-picture is stored in the reduced frame stores 370 at a reduced image resolution of (S/X×T/Y). Motion compensation is conducted at the reduced block size in the functional unit 340. The original motion vector 530 between the original current frame and the original reference frame is scaled down to arrive at a reduced motion vector 570 between the current reduced frame 550 and the reduced reference frame 560. As shown in FIG. 5B, the scale factors are assumed to be {2, 2}. The original motion vector V is transformed to a reduced motion vector 570 V_red=V/2=(mv_x/2, mv_y/2) for the blocks of sizes [4, 4] in the reduced reference frame. This reduced motion vector 570 is used to interpolate a 4×4 block in the current frame. The interpolated result is then added to the block 430 from the functional unit 335 in the functional unit 350. The steps are repeated for every block that has a motion vector to produce a motion-compensated reduced video frame at reduced resolution. It is noted that if a block in a P-picture is Intra-coded, its decoding steps are very similar to the decoding path for such blocks for an I-picture.

After I-picture decoding and the first P-picture decoding, an immediate P-picture in the video bitstream can be built using either previously decoded I-picture or P-picture stored in the reduced frame store 370. The subsequent decoded P-pictures are also constructed in reduced resolution.

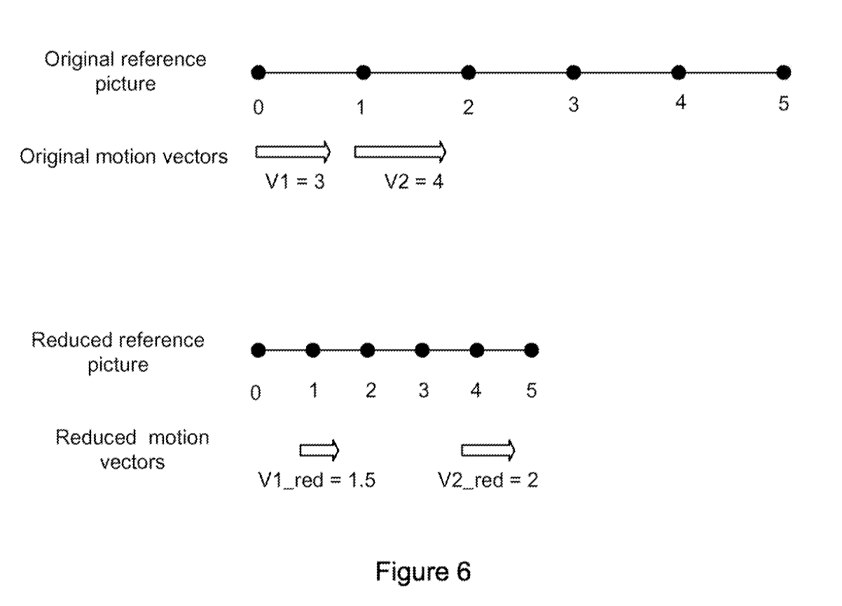

The disclosed systems and methods are compatible with motion vectors that are quantized at full-pixel, half-pixel or quarter-pixel. Referring to FIG. 6, two exemplified motion vectors V1=3 and V2=4 (assuming only motion in the horizontal direction is non-zero) are parsed from the input bitstream. In the reduced reference frames, the reduced motion vectors can respectively be V1_red=3/2=1.5 and V2_red=4/2=2 for scale factors {2, 2}. Therefore, in the disclosed system, one has to use half pixel interpolation which represents more accurate motion prediction whereas the original motion vectors V1 and V2 only require full pixel interpolation. In the disclosed system, depending on the video codec and its specific motion interpolation schemes, one has to adjust the motion interpolation schemes due to motion vector scaling.

Similarly, the disclosed methods and systems can be applied to decoding of B-picture, to obtain their associated motion vectors, to perform reduced motion compensation and to obtain a reduced B-picture. The above disclosed methods and systems can also be applied to other video codecs that may have different rules and equations for interpolating the reference frame from the motion vectors.

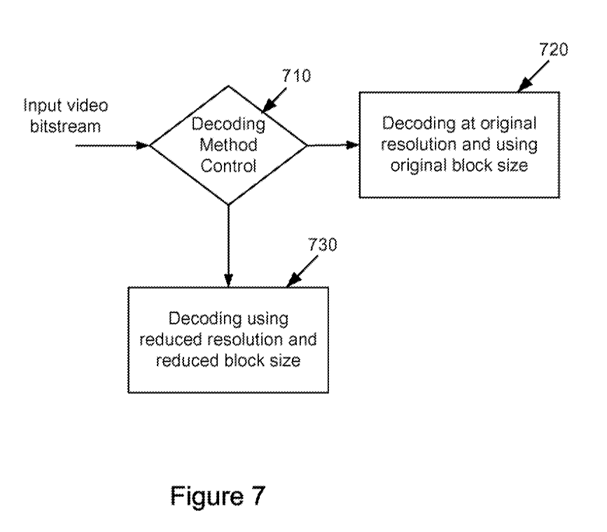

In some embodiments, the disclosed systems and methods provides, referring to FIG. 7, an adaptive system 700 that allows the video processing to be conducted at the original image resolution and block sizes in the functional unit 720, or at reduced image resolution and reduced block size in the functional unit 730. A functional unit 710 determines which video decoding method is to be used in accordance to the encoding method, video resolution, and bit rates of the input video bitstream, and decoding capabilities of the hardware configuration. If the hardware system is capable of handling video decoding at the original image resolution at desirable speed, the input video bitstream is decoded by the functional unit 720. Otherwise, the input video bitstream is decoded by the functional unit 730.

The above disclosed systems and methods may include one or more of the following advantages. The disclosed systems and method simplify video decoding by lifting the constraints of standard decoding specifications. The block sizes are reduced to achieve higher decoding speed without significantly impacting visual perception of the decoded video images. The faster decoding can result in several beneficial consequences. For example, simpler and lower cost CPU/DSP and less memory can perform the decoding job that requires faster and more expensive DSP/CPU and more memory using conventional decoding techniques. System is thus simplified and cost is reduced. In another example, a CPU/DSP can perform a decoding job at a lower clock frequency, wherein conventional decoding techniques require the same CPU/DSP to run at much higher clock frequency. Power consumption can thus be reduced.

The disclosed system and methods are able to decode video bitstream faster than some conventional video decoding systems. The faster video decoding can allow real-time video decoding to be achieved in a wide range of hardware configurations, where real-time video decoding is previously not possible. For video codec decoding system that uses specialized integrated circuits (IC), the disclosed systems and methods allow simpler decoding circuits with fewer gate counts and less memory usage. As a result, the IC can be cheaper to manufacture or run at a lower clock frequency, which can result in significant reduction in die size, cost and power consumption.

The disclosed system and methods are flexible. They are applicable to essentially all the open coding standards such as H.263, MPEG1, MPEG2, MPEG4, H.264, VC-1, and AVS (China standard), as well as proprietary compression/decompression standards such as WMV, RealVideo, DIVX, and XVID.

Moreover, the disclosed system and methods can also be flexibly implemented. The disclosed system and methods can be implemented as embedded software that runs on Central Processing Unit (CPU) and Digital Signal Processor (DSP), or in dedicated integrated circuit such as application specific integrated circuit (ASIC). The disclosed system and methods can also be implemented in firmware stored in non-volatile computer memories.

Furthermore, the disclosed decoding system and methods are not bound by certain limitations in some conventional video standards. The decoding can be conducted at high speed while producing video images at acceptable level of image quality.

It is understood that the disclosed systems and methods are compatible with other configurations and processes without deviating from the present invention. For example, the macroblocks may have different sizes such as 8×8, 16×16, 32×32, 16×32 etc. The scaling factor for the block size reduction can take 2, 3, 4 or other values. The scaling factor can also be different along the two dimensions of the video images. Although MPEG4 (ISO/IEC 14496-2:2001) and other standards are used above to illustrate the disclosed concepts, the disclosed systems and methods are not limited to the specific codec standards used. The disclosed systems and methods can be implemented using different approaches such as hardware, software, and firmware. For example, a fast MPEG-2 decoder can be implemented using disclosed systems and methods using standard computer processing chips instead of specialized hardware systems which is typically more costly. The inverse transforms for the blocks and reduced blocks can include IDCT and other inverse transform techniques.

What is claimed is:

1. A system for video decoding, comprising;
a first functional unit configured to receive video data comprising a first input video frame and a second input video frame, wherein the first input video frame comprises a block encoded by an M×N array of DCT coefficients for the first input video frame, wherein the first functional unit is configured to select a subset of the DCT coefficients in the M×N array to obtain selected DCT coefficients, wherein M and N are integers;
a second functional unit configured to dequantize the selected DCT coefficients to produce dequantized DCT coefficients without dequantizing the DCT coefficients that are not selected by the first functional unit;
a third functional unit configured to inversely transform the dequantized DCT coefficients to produce a reduced pixel block;
a fourth functional unit configured to produce a reduced motion vector associated with the reduced pixel block between the first input video frame and the second input video frame, wherein the fourth functional unit is configured to produce a motion-compensated reduced block using the pixel block according and the reduced motion vector; and
a fifth functional unit configured to add the motion-compensated reduced block to the reduced pixel block to form a portion of an output video frame.

2. The system of claim 1, wherein the first functional unit configured to extract the selected DCT coefficients in the M×N array from the video data, and not to extract from the video data the DCT coefficients that are not selected in the M×N array.

3. The system of claim 1, wherein the first functional unit is configured to extract from the video data an original motion vector associated with the displacement of the block between the first input video frame and the second input video frame to compute the reduced motion vector using the original motion vector and a scaling factor between all the DCT coefficients in the M×N array and the selected DCT coefficients in the M×N array.

4. The system of claim 1, wherein at least one of the selected DCT coefficients is associated with a frequency lower than that associated with one of the DCT coefficients not selected by the second functional unit.

5. The system of claim 1, wherein the selected DCT coefficients form a P×Q array, wherein P and Q are integers, wherein M/P and N/Q respectively define scaling factors between the block and the reduced block.

6. The system of claim 5, wherein the fourth functional unit is configured to obtain an original motion vector associated with the displacement of the block from the first input video frame and the second input video frame and to compute the reduced motion vector by dividing a component of the original motion vector by one of the scaling factors.

7. The system of claim 5, wherein at least one of M/P or N/Q is a power of 2.

8. The system of claim 5, further comprising a sixth functional unit configured to determine the scaling factors in accordance with a processing frequency or a memory size characterizing the system for video decoding.

9. A computer program product, encoded on a tangible program carrier, operable to cause data processing apparatus to perform operations comprising:
receiving video data comprising a first input video frame and a second input video frame, wherein the first input video frame comprises a block encoded by an M×N array of DCT coefficients for the first input video frame;
selecting a subset of the coefficients in the M×N array to obtain selected DCT coefficients, wherein M and N are integers;
dequantizing the selected DCT coefficients to produce dequantized DCT coefficients without dequantizing the DCT coefficients that are not selected by the first functional unit;
inversely transforming the dequantized DCT coefficients to produce a reduced pixel block;
producing a reduced motion vector associated with the reduced pixel block between the first input video frame and the second input video frame;
producing a motion-compensated reduced block based on the pixel block according to the reduced motion vector; and
adding the motion-compensated reduced block to the reduced pixel block to form a portion of an output video frame.

10. The computer program product of claim 9, wherein the operations further comprises extracting the selected DCT coefficients in the M×N array from the video data without extracting from the video data the DCT coefficients that are not selected in the M×N array.

11. The computer program product of claim 9, wherein at least one of the selected DCT coefficients in the M×N array is associated with a frequency lower than that associated with one of the DCT coefficients not selected in the M×N array.

12. The computer program product of claim 9, wherein the selected DCT coefficients are configured to form a P×Q array, wherein P and Q are integers, and wherein M/P and N/Q define scaling factors between the block and the reduced block, wherein the operations further comprises:
obtaining an original motion vector associated with the displacement of the block from the first input video frame to the second input video frame; and
determining the reduced motion vector by dividing a component of the original motion vector by one of the scaling factors.

13. The computer program product of claim 9, the operations further comprises:
determining a processing frequency or a memory size characterizing a computing system for video decoding; and
determining M and N in accordance with the processing frequency or the memory size of the computing system.

14. A method for video decoding, comprising:
receiving video data comprising a first input video frame and a second input video frame, wherein the first input video frame comprises a block encoded by an M×N array of DCT coefficients for the first input video frame;
selecting a subset of the DCT coefficients in the M×N array to obtain selected DCT coefficients, wherein M and N are integers;
extracting the selected DCT coefficients from the video data without extracting from the video data the DCT coefficients that are not selected in the M×N array;
dequantizing the selected DCT coefficients to produce dequantized DCT coefficients without dequantizing the DCT coefficients that are not selected by the first functional unit;
inversely transforming the dequantized DCT coefficients to produce a reduced pixel block;
producing a reduced motion vector associated with the reduced pixel block between the first input video frame and the second input video frame;
producing a motion-compensated reduced block using the reduced pixel block and the reduced motion vector; and
adding the motion-compensated reduced block to the reduced pixel block to form an output reduced pixel block.

15. The method of claim 14, wherein at least one of the selected DCT coefficients in the M×N array is associated with a frequency lower than that associated with one of the DCT coefficients not selected in the M×N array in the step of selecting.

16. The method of claim 14, wherein the selected DCT coefficients form a P×Q array, wherein P and Q are integers, and wherein M/P and N/Q define scaling factors between the block and the reduced block.

17. The method of claim 16, wherein at least one of M/P or N/Q is a power of 2.

18. The method of claim 16, further comprising:
extracting from the video data an original motion vector associated with the displacement of the block between the first input video frame and the second input video frame; and
computing the reduced motion vector using the original motion vector, M/P, and N/Q.

19. The method of claim 18, further comprising computing the reduced motion vector by dividing a component of the original motion vector by M/P or N/Q.

20. The method of claim 14, further comprising filtering the output reduced pixel block to remove artifacts along the boundaries of the output reduced pixel block.

21. The method of claim 14, further comprising:
determining a processing frequency or a memory size characterizing a computing system configured to execute the steps of selecting, extracting, dequantizing, inversely transforming, producing a reduced motion vector, producing a motion-compensated reduced block, or adding; and
determining M/P and N/Q in accordance with the processing frequency or the memory size characterizing the computing system.

22. A method for video decoding, comprising:
receiving video data comprising a first input video frame and a second input video frame, wherein the first input video frame comprises a block encoded by an M×N array of DCT coefficients for the first input video frame;
selecting P×Q of the DCT coefficients in the M×N array to obtain selected DCT coefficients, wherein at least one of the selected DCT coefficients in the M×N array is associated with a frequency lower than that associated with one of the DCT coefficients not selected in the M×N array in the step of selecting, wherein M, N, P, and Q are integers, P×Q is smaller than M×N, and M/P and N/Q define scaling factors between the block and the reduced block;
extracting the selected DCT coefficients in the M×N array from the video data without extracting from the video data the DCT coefficients that are not selected in the M×N array;
dequantizing the selected DCT coefficients to produce dequantized DCT coefficients without dequantizing the DCT coefficients that are not selected by the first functional unit;
inversely transforming the dequantized DCT coefficients to produce a reduced pixel block;
extracting from the video data an original motion vector associated with the displacement of the block between the first input video frame and the second input video frame;
computing a reduced motion vector associated with the reduced pixel block between the first input video frame and the second input video frame in response to the original motion vector and the scaling factors;
producing a motion-compensated reduced block using the reduced pixel block and the reduced motion vector; and
adding the motion-compensated reduced block to the reduced pixel block to form an output reduced pixel block.

23. The method of claim 22, further comprising filtering the output reduced pixel block to remove artifacts along the boundaries of the output reduced pixel block.

24. The method of claim 22, further comprising computing the reduced motion vector by dividing a component of the original motion vector by M/P or N/Q.

25. The method of claim 22, further comprising:
determining a processing frequency or a memory size characterizing a computing system configured to execute the steps of selecting, extracting, dequantizing, inversely transforming, producing a reduced motion vector, producing a motion-compensated reduced block, or adding; and
determining M/P and N/Q in accordance with the processing frequency or the memory size characterizing the computing system.
